(19) United States
(12) Patent Application Publication
(10) Pub. No.: US 2023/0242820 A1
(43) Pub. Date: Aug. 3, 2023

(54) COPOLYMERIZATION OF SULFUR WITH BIO-OIL OR BIOMASS MONOMERS

(71) Applicants: Elham Fini, Phoenix, AZ (US); Masoumeh Mousavi, Tempe, AZ (US)

(72) Inventors: Elham Fini, Phoenix, AZ (US); Masoumeh Mousavi, Tempe, AZ (US)

(21) Appl. No.: 18/162,162

(22) Filed: Jan. 31, 2023

Related U.S. Application Data
(60) Provisional application No. 63/305,000, filed on Jan. 31, 2022.

(51) Int. Cl. C10C 3/02; C10C 3/10; C08K 3/06; C08L 95/00

(52) U.S. Cl. CPC C10C 3/023; C10C 3/10; C08K 3/06; C08L 95/00; C08L 2555/60

(57) ABSTRACT

Sulfur copolymerization includes combining elemental sulfur with modified bitumen to yield a mixture, blending the mixture, and curing the mixture to yield a copolymerized modified bitumen. The modified bitumen includes waste vegetable oil. Inverse vulcanization includes combining an unsaturated fatty acid and an alkaline earth metal (hydr)oxide to yield a mixture, combining elemental sulfur with the mixture, and processing the mixture to yield a sulfur copolymer.

### CROSS-REFERENCE TO RELATED APPLICATION

This application claims the benefit of U.S. Patent Application No. 63/305,000 filed on Jan. 31, 2022, which is incorporated herein by reference in its entirety.

### STATEMENT OF GOVERNMENT SUPPORT

This invention was made with government support under grant number 1928807 awarded by the National Science Foundation. The government has certain rights in the invention.

### TECHNICAL FIELD

This invention relates to copolymerization of sulfur with bio-oil or biomass monomers.

### BACKGROUND

Traditional vulcanization uses sulfur to crosslink polymer chains in rubber. Inverse vulcanization is a copolymerization process by which stable organosulfur polymers are made from elemental sulfur and organic crosslinkers. In vulcanization, small amounts of sulfur are used to crosslink the rubber chains or other targeted polymers. In inverse vulcanization, high-sulfur content (typically 50-90% sulfur by mass) polymers are obtained through crosslinking the polysulfide chains using small quantities of alkene co-monomer. During inverse vulcanization, the molten sulfur acts as the solvent, monomer, and initiator, and the resulting thiopolymer is stabilized with the organic crosslinker. In catalytic inverse vulcanization, an accelerator is used to reduce the reaction temperature, increase the reaction rate, and reduce the production of hydrogen sulfide.

### SUMMARY

This disclosure describes copolymerization of sulfur with bio-oil or biomass monomers. In some aspects, the copolymerization occurs in bitumen. In some aspects, the copolymerization includes inverse vulcanization with bio-oils or catalyzed inverse vulcanization with bio-oils and alkaline earth (hydr)oxides. For the catalyzed inverse vulcanization, unsaturated monomers in the bio-oils (e.g., unsaturated fatty acids) act as an organic crosslinker, and the alkaline earth salt of the fatty acid acts as an activator. In one example, the monomer is oleic acid and the alkaline earth (hydr)oxide is magnesium or calcium. As described herein, the fatty acids crosslink polymerized sulfur in the presence of the alkaline earth metal (hydr)oxide, lowering the reaction time and temperature required for the polymerization to occur. The bio-oils can be waste bio-oils. The sulfur can be obtained as a by-product from petrochemical processes. Polymers resulting from this process can be used in adhesives and construction composites.

In a first general aspect, sulfur copolymerization includes combining elemental sulfur with modified bitumen to yield a mixture, blending the mixture, and curing the mixture to yield a copolymerized modified bitumen. The modified bitumen includes waste vegetable oil.

Implementations of the first general aspect can include one or more of the following features.

In some cases, blending the mixture includes melt-blending. In some implementations, the first general aspect further includes melt-blending at a temperature between about 160° C. and about 200° C. The curing can occur at ambient temperature. In some cases, the mixture includes between about 5 wt % and about 15 wt % of the elemental sulfur. In some implementations, the waste vegetable oil includes one or more unsaturated organic monomers. In some cases, the one or more unsaturated organic monomers independently include one or more unsaturated alcohols or unsaturated fatty acids. The unsaturated alcohols can include glycerols. In some implementations, the elemental sulfur reacts to yield polysulfide chains. The polysulfide chains can form a covalent bond with one of the unsaturated organic monomers.

In a second general aspect, inverse vulcanization includes combining an unsaturated fatty acid and an alkaline earth metal (hydr)oxide to yield a mixture, combining elemental sulfur with the mixture, and processing the mixture to yield a sulfur copolymer.

Implementations of the second general aspect can include one or more of the following features.

In some cases, a weight ratio of the unsaturated fatty acid and the alkaline earth metal (hydr)oxide is in a range of about 2:1 to about 1:2. In some implementations, the unsaturated fatty acid has a carbon chain length of about 6 carbons to about 22 carbons. The unsaturated fatty acid can be oleic acid. In some implementations, the second general aspect further includes sourcing the unsaturated fatty acid from a bio-oil. In some cases, the bio-oil is waste vegetable oil. The alkaline earth metal (hydr)oxide can include magnesium oxide or calcium oxide. In some cases, combining the unsaturated fatty acid and the alkaline earth metal (hydr)oxide occurs at a temperature between 125° C. and 150° C. In some implementations, combining the unsaturated fatty acid and the alkaline earth metal (hydr)oxide occurs in a low shear mixer. The unsaturated fatty acid and the alkaline earth metal (hydr)oxide can react to form a metal salt activator.

Advantages provided by processes described herein include the use of sustainable sources of bio-oils (e.g., waste vegetable oil), reduction of the unwanted crystallization of sulfur, reduction of energy consumption by reducing polymerization temperature, the use of environmentally friendly activators (e.g., based on MgO), and the reduction of the time and temperature of polymerization conditions.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIGS. 1A-1D depict components of waste cooking oil cis-vaccenic acid, trans-2-undecen-1-ol, 10(E),12(Z)-conjugated linoleic acid, and 2-linoleoyl glycerol, respectively. FIGS. 1E and 1F depict the process of sulfur radical attack on the most reactive positions of cis-vaccenic acid and 10(E),12(Z)-conjugated linoleic acid, respectively.

FIG. 2 depicts four stages of sulfur radical attack on 7-tetradecene.

FIGS. 3A and 3B show the free energy and bond energy, respectively, for the first sulfur radical attack on the four molecules depicted in FIGS. 1A-1D. FIGS. 3C and 3D show the free energy and bond energy, respectively, for the second sulfur radical attack on the four molecules depicted in FIGS. 1A-1D.

FIG. 4 depicts sulfur chains reacting with dicyclopentadiene (DCPD).

FIG. 5A shows Fourier transform infrared (FTIR) spectra of sulfur-modified bitumen with (upper curve) and without (lower curve) thermal curing. FIG. 5B shows the complex modulus at 52° C. of sulfur-modified bio-modified bitumen. FIG. 5C shows FTIR spectra of heating ramps from 30° C. to 180° C. FIG. 5D shows the peak intensity of S═C bond at 1263 cm⁻¹ as temperature increases from 30° C. to 180° C.

FIG. 6A depicts a sulfur radical attack on a double bond of oleic acid to produce a carbon-centered radical. FIG. 6B depicts the chemical reaction between the sulfur radical and oleic acid through the allylic radical.

FIGS. 7A-7C depict the molecular structure and binding energies of oleate (C₁₈H₃₃O₂)⁻ coordinated to Mg, Zn, and Ca, respectively, as activators in inverse vulcanization.

### DETAILED DESCRIPTION

This disclosure describes copolymerization of sulfur with unsaturated bio-oil or biomass monomers. In some aspects, the copolymerization includes inverse vulcanization with unsaturated bio-oil or biomass monomers or catalyzed inverse vulcanization with unsaturated bio-oil or biomass monomers and alkaline earth (hydr)oxides. For catalyzed inverse vulcanization, unsaturated monomers in the bio-oils (e.g., unsaturated fatty acids) act as an organic crosslinker, and the alkaline earth salt of the fatty acid acts as an activator. As used herein, “activator” generally refers to a component that acts as a catalyst but is incorporated in the final product and therefore not reclaimed after polymerization. The bio-oils can be waste bio-oils (e.g., waste vegetable oil or cooking oil). Suitable biomass examples include algae and waste products from agricultural products such as peanuts and walnuts. The sulfur can be obtained as a by-product from petrochemical processes. Polymers resulting from this process can be used in adhesives and construction composites.

Copolymerization of Sulfur and Hydrocarbons in Bitumen. Copolymerization of the sulfur in high-sulfur bitumen with bio-oil (e.g., waste cooking oil) rich in unsaturated organic monomers can lead to strong intermolecular interactions and formation of sulfur-carbon bonds within the bitumen matrix, enhancing bitumen's rheological properties as well as its performance properties. In one embodiment, elemental sulfur is combined with a modified bitumen that includes bio-oil to yield a mixture, and the mixture is blended. The blended mixture is cured (e.g., at ambient temperature for a number of days) to yield a copolymerized modified bitumen with increased cohesion and subsequently higher elasticity. In another example, samples were thermally cured (e.g., melt-blended). The temperature of the melt-blending can be between about 160° C. and about 200° C. The mixture can include between about 5 wt % and about 15 wt % of the elemental sulfur.

Other embodiments include copolymerization of unsaturated organic monomers in bio-oils with elemental sulfur to yield high-sulfur content copolymers by crosslinking polysulfide chains with the unsaturated organic monomers. The elemental sulfur reacts to yield polymeric sulfur chains. “Crosslinking” includes the polysulfide chains forming one or more covalent bonds with the unsaturated organic monomers. The unsaturated organic monomers can include one or more unsaturated alcohols or unsaturated fatty acids. Examples of suitable unsaturated organic monomers include glyceryl monooleate, cis-vaccenic acid, trans-2-undecen-1-ol, 12(Z)-conjugated linoleic acid, 2-linoleoyl glycerol, glycidyl oleate, and dihomolinoleic acid. Reaction conditions for the unsaturated organic monomer-sulfur copolymerization, which include melting the elemental sulfur, adding and blending the unsaturated organic monomer, and curing the mixture for a number of hours, can be similar to those for copolymerization reactions disclosed for modified bitumen.

Catalyzed Inverse Vulcanization. An inverse vulcanization process catalyzed with alkaline earth (hydr)oxides and including unsaturated fatty acids and elemental sulfur is described. The inverse vulcanization process includes combining an unsaturated fatty acid and an alkaline earth metal (hydr)oxide to yield a mixture, combining elemental sulfur with the mixture, and processing the mixture to yield a sulfur copolymer. A weight ratio of the unsaturated fatty acid and the alkaline earth metal (hydr)oxide can be in a range of about 2:1 to about 1:2. Suitable fatty acids include unsaturated fatty acids having a carbon chain length in a range of about 6 carbons to about 22 carbons. Suitable alkaline earth metals include magnesium and calcium. In one example, the fatty acid is oleic acid and the alkaline earth (hydr)oxide is magnesium. As described herein, the fatty acids crosslink polymerized sulfur in the presence of the alkaline earth metal (hydr)oxides to yield high-sulfur content (typically 50-90% sulfur by mass) copolymers. The metal salt of the fatty acid (the activator) acts as a catalyst, lowering the reaction time and temperature required for the polymerization to occur. The bio-based fatty acids, such as oleic acid, can be sustainably sourced from bio-oils (e.g., waste cooking oil including waste vegetable oil). High-sulfur content polymers (typically 50-90% sulfur by mass) can be obtained through crosslinking the polysulfide chains using small quantities of the fatty acids. The sulfur can be obtained as a by-product from petrochemical processes. Polymers resulting from this process can be used in adhesives and construction composites.

### Examples

### Copolymerization of Sulfur and Hydrocarbons in Bitumen

Polymerization. For polymerization with dicyclopentadiene (DCPD), sulfur was heated in a pot over an electric hotplate, with the stirring provided by hand blending. The sulfur was fully melted at 160° C., and then DCPD was added. The mixture was continuously stirred, and its temperature was kept at 160° C. for 2 hours. The polymerization was detected when the color of the mixture became increasingly darker, until a dark brown near-solid material was obtained. Before the mixture lost its heat, it was poured into molds and kept in an oven at 140° C. for 12 hours. It was then allowed to cool before being tested for its mechanical properties.

Modified bitumen. The bitumen used was PG 64-22 having properties provided in Table 1. The waste cooking oil (WCO) was obtained from Mahoney Environmental Inc., Phoenix, Ariz., a processing facility for waste cooking oil. Sulfur with reagent grade was provided by Fisher Science Education. To prepare the specimens, 10 wt % sulfur was added to bitumen (that contained waste cooking oil) and blended using a high-shear mixer at 3000 rpm. The sulfur-modified samples were cured at ambient temperature for 60 days before testing. In a second scenario, samples were melt-blended at 180° C. for 30 min, referred to as thermal curing.

TABLE 1
Basic properties of PG 64-22

| Property | Value | | Testing method |
|---|---|---|---|
| Specific gravity @15.6° C. | 1.041 | | ASTM D70 |
| Penetration @25° C. | 70 0.1 | mm | ASTM D5 |
| Softening point | 46.0° | C. | ASTM D36 |
| Ductility @ 15° C. | >100 | cm | ASTM D113 |
| Cleveland open cup method flash point | 335° | C. | ASTM D92 |
| Mass change after rolling thin-film | −0.013% | | ASTM D6 |
| oven test | | | |
| Absolute viscosity @ 60° C. | 179 | Pa · s | ASTM D2171 |
| Stiffness @−12° C., 60 s | 85.8 | MPa | ASTM D6648 |

Attenuated Total Reflectance Fourier-Transform Infrared Spectroscopy (ATR-FTIR).

For ATR analysis, built-in ATR with a diamond crystal was used in a Thermo Fisher Nicolet iS50 equipped with a DTGS detector. Individual samples were placed on the ATR crystal to completely cover the 1-mm crystal surface. Uniform pressure was applied on all samples using the built-in pressure clamp. Scan parameters used were 128 scans and a resolution of 4 cm⁻¹. Continuous heat monitoring was used with a temperature-controlled diamond ATR. Data was collected from ambient temperature to 180° C.; changes were also monitored as the sample cooled to ambient temperature. Evaluation of peak areas was carried out using Thermo Nicolet TQ analyst software. Analysis of spectra was performed with OMNIC software. All peak areas were calculated with appropriate baseline corrections. Difference spectra were evaluated using the subtract function in OMNIC software. To understand if the changes observed in the end-point-heated samples corresponded to a continuous change in bond dynamics, samples were analyzed while being heated to 180° C. ATR-FTIR spectra were recorded as the sample temperature was ramped from 30° C. to 180° C., which allowed continuous analysis at the same spot in the sample to minimize any variability related to heterogeneity.

Gas Chromatography-Mass Spectroscopy. Waste cooking oil was analyzed using a gas chromatography—mass spectrometer (GC-MS) for chemical and molecular composition. Each sample was dissolved in dichloromethane and filtered through a 0.2-μm PTFE filter prior to injection into the GC column. A DB-5 column (30 m×250 μm×0.25 μm) was used to identify molecular species of the waste cooking oil. As expected, non-soluble compounds are excluded and are not accounted for in this study. Accordingly, the underlying molecular interactions with sulfur as described herein are based on molecules of the waste cooking oil that are identified by GC-MS. The carrier gas (helium) was maintained at 1 ml/min throughout the analysis. The samples were diluted 10-fold before 1 μl was injected into the column in split-less mode. The inlet temperature was maintained at 280° C.; the transfer-line temperature was 250° C., and the source temperature was 230° C. The chromatogram and the major peaks were processed and integrated using ChemStation and matched to the NIST17 database.

Rheometry. Rheological analysis was performed using a dynamic shear rheometer (Anton Paar MCR 302). An oscillation test was performed at 52° C. and angular frequencies ranged from 0.1-100 rad/s using a parallel-plate setup. The sample was made into a disk 8 mm in diameter and 2 mm thick and placed in the parallel-plate setup to perform the test. The complex modulus (G*) was calculated using Eq. 1 from shear strain and shear stress data collected during the test (Equations 2 and 3, respectively),

$${G}^{*} = \frac{{τ}_{max}}{{γ}_{max}} \qquad ( 1 )$$

$$γ = {( \frac{θ r}{h} )}_{max} \qquad ( 2 )$$

$$τ = \frac{2 T}{π {r}_{max}^{3}} \qquad ( 3 )$$

where γₘₐₓ is maximum strain, τₘₐₓ is maximum stress, T is maximum applied torque, r is the radius of the sample, θ is the deflection (rotational) angle, and h is the height of the sample.

DFT calculations and MD simulations. Quantum-mechanical calculations in a dispersion-corrected density functional theory (DFT-D) framework were used to provide an atomistic description of the molecular system's performance. All optimizations were performed through the DMol3 module of the Accelrys Materials Studio program package (version 6.0). The generalized gradient approximation (GGA) and Perdew-Burke-Ernzerhof (PBE) functional were used to treat exchange-correlation interactions. PBE is the most universal GGA that could be applied to both molecules and solids. Errors of nonempirical functionals, such as PBE, usually have a “systematic” tendency. The systematic errors of PBE make it easier to estimate the target property. Moreover, these functionals provide a high accuracy for relative quantities such as bond length changes, frequency shifts, and energy differences.

In the MD simulation, a random algorithm was used to produce a sulfur composite modified by WCO. Herein, 80% sulfur chains and 20% WCO were used for the composite, attached where the tendencies are maximum, e.g., where the carbon-sulfur bond is stable. The model was intended to preserve the periodic boundary conditions in three dimensions, thus presenting a suitable model for the sulfur composite under thermodynamic interactions. Five hydrocarbons were used to construct the bitumen matrix: asphaltene-phenol; aromatic DOCHN; resin-benzobisbenzothiophene; saturate-hopane; and resin-thioisorenieratane. The 5 hydrocarbons form a conglomerate, held together mainly by weak vdW forces inside the bitumen matrix. The bitumen matrix used in the simulation was a box with dimensions of 30×30×30 Å. The COMPASS force field was used to model the interatomic interactions between a sulfur polymer and the bitumen matrix. The designed system reaches an equilibrium at its lowest energy level. Optimizing the structure of the nanocomposites and minimizing the energy level were achieved using the SMART method, which is a combination of the steepest descent, conjugate gradient, and Newton-Raphson methods. In order for the system to reach P=0.0001 GPa (air pressure) and T=400 K, a total analysis time of up to 500 ps with NPT ensemble was used to optimize the shape of the supercell and allow for the interactions to happen at 400 K. This was followed by 500 ps stabilization in 298 K; this process was designed to resemble the mixing and reacting process at high temperatures and stabilization at room temperature. Results were extracted under an NVT ensemble for 500 ps in 298 K to ensure constancy. A Nose thermostat and Berendsen barostat were set to control the temperature and pressure, respectively.

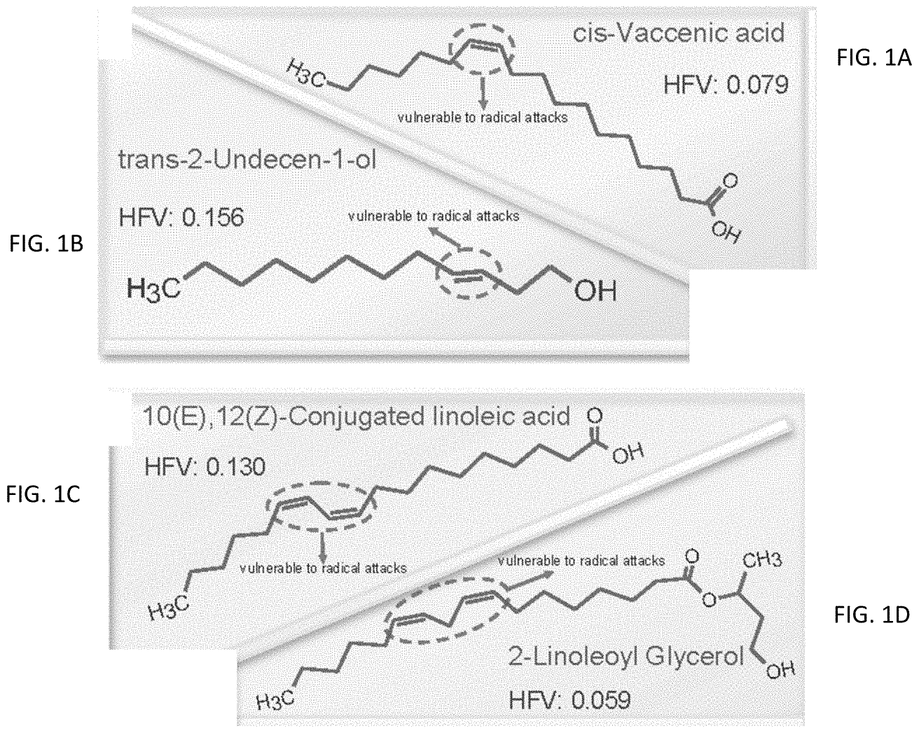

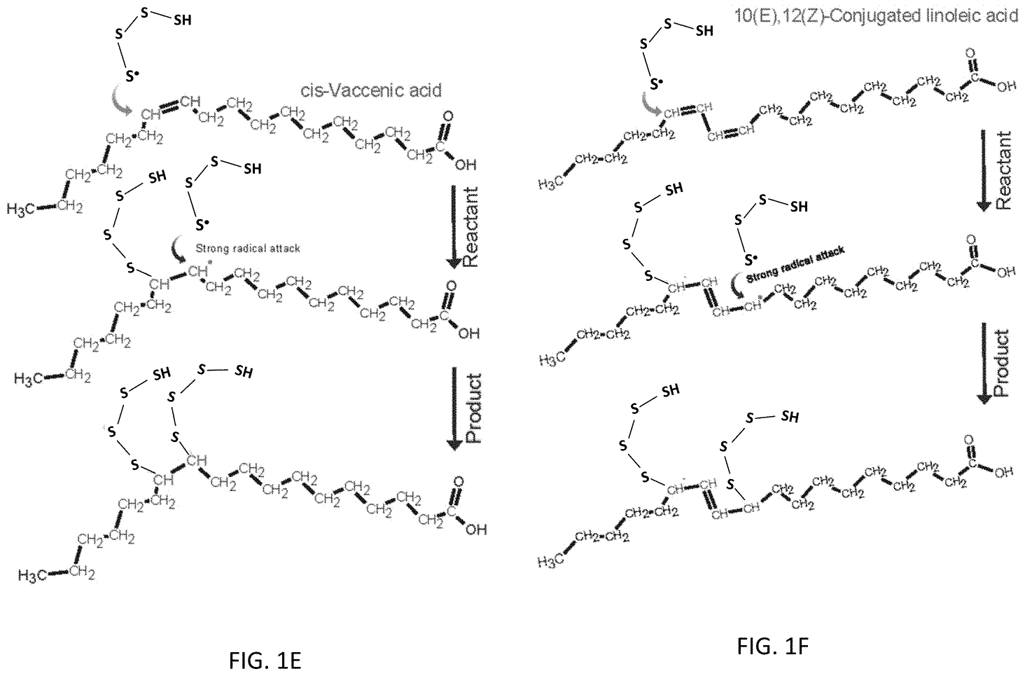

Screening crosslinkers. Elemental sulfur can take many forms; the most common of its allotropes is its ring structure, which is observed as S₈, S₇, or S₆. Temperatures over 160° C. can cause these rings to break open and form radical chains, which at a larger scale form a highly reactive conglomerate. The reactivity of the radical chains makes them a suitable candidate for forming sulfur-hydrocarbon (S—C) copolymers through radical attacks. The stability of the bonds they form is the main limitation of the produced polymers. Given certain conditions, this S—C bonding can turn into a fusion mechanism; molecular models have been used to analyze this possibility for the prominent species in waste cooking oil (WCO) provided in Table 2. Among those prominent species, four hydrocarbons showed suitability for creating such polymers: cis-vaccenic acid, trans-2-undecen-1-ol, 10(E),12(Z)-conjugated linoleic acid, and 2-linoleoyl glycerol shown in FIGS. 1A-1D, respectively. These have at least one property in common: a double bond in a long carbon chain. It is the relative vulnerability of this bond, as determined through examination of the highest Fukui value (HFV) in each molecule, which enables reactive sulfur chains to attach to the main carbon chain. The reaction mechanisms are illustrated in FIGS. 1E and 1F.

TABLE 2
Main ingredients of the Waste Vegetable Oil

| Waste | | polarizability | |
|---|---|---|---|
| Vegetable Oil | % | (α) | Molecular Structure |
| cis-Vaccenic acid | 4 4 | 216.09 | 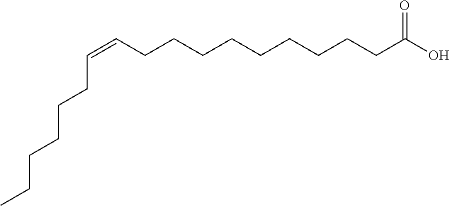 [SMILES: CCCCCC/C=C\CCCCCCCCCC(=O)O] |
| Dihomolinoleic acid | 1 4 | 225.09 | 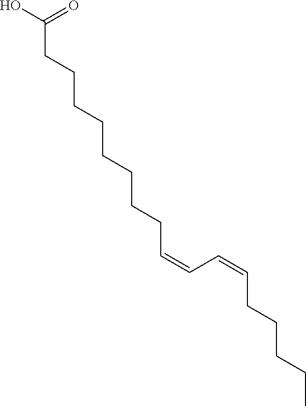 [SMILES: CCCCC/C=C\C=C/CCCCCCCCC(=O)O] |
| Octadecanoic acid | 1 2 | 216.40 | 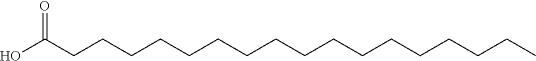 [SMILES: CCCCCCCCCCCCCCCCCC(=O)O] |
| Glyceryl monooleate | 5 | 260.42 | 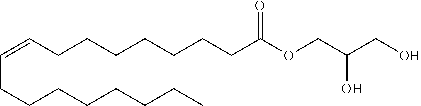 [SMILES: CCCCCCCC/C=C\CCCCCCCC(=O)OCC(O)CO] |
| 2-Undecen-1- ol, (E)- | 3 | 134.16 | 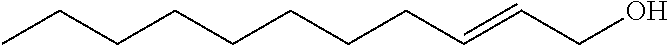 |
| 2- Linoleoylglycerol | 2 | 260.76 | 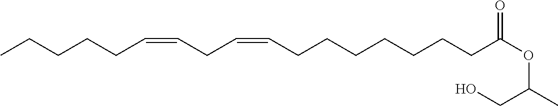 [SMILES: CCCCC/C=C\C/C=C\CCCCCCCC(=O)OC(C)CO] |
| Glyeidyl oleate | 2 | 253.39 | 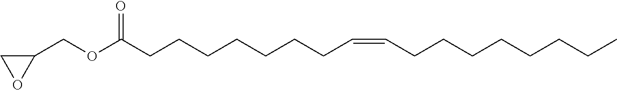 [SMILES: CCCCCCCC/C=C\CCCCCCCC(=O)OCC1CO1] |
| Palmitic acid vinyl ester | 2 | 217.92 | 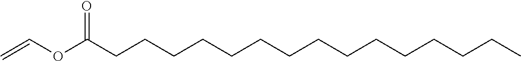 [SMILES: C=COC(=O)CCCCCCCCCCCCCCC] |
| 10-Undecynoic acid | 2 | 126.57 | 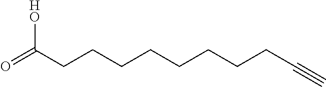 |
| Glyeidyl palmitate | 1 | 228.91 | 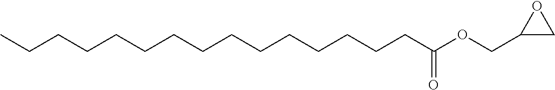 [SMILES: CCCCCCCCCCCCCCCC(=O)OCC1CO1] |

The hydrocarbons shown in FIGS. 1A-1D, although similar, differ slightly from each other. 10(E),12(Z)-conjugated linoleic acid has two alternate double bonds, and cis-vaccenic acid has one double bond. When attacked by radical sulfur chains, an S—C bond forms between the two species; the S—C bond breaks off the double bond and frees one of the neighboring carbon atoms to become available for a follow-up reaction. The reaction is the same: a second radical sulfur chain attacks the most reactive carbon and increases the hydrocarbon's degree of saturation. However, there are subtle changes when the number and the placement of the double bonds differ; these differences affect the location of the second S—C bond. In species with a single C═C bond, the location for the second radical attack is most likely the carbon atom on the opposite side of the double bond, which is the case for cis-vaccenic acid shown in FIG. 1E. For the 10(E),12(Z)-conjugated linoleic acid that has two alternate double bonds, it becomes more complex. After the attachment of the first radical chain, the resulting radical electron does not stay localized on the adjacent carbon. Instead, it shifts and replaces the remaining double bond. This shift changes the location of the most reactive carbon to the one on which the radical electron is localized as shown in FIG. 1F, where the second sulfur radical chain will attack. The sulfur radical attack continues until the remaining double bonds have all reacted and S—C bonds are created in their place.

Fukui values mark the most reactive atoms in two prominent species (cis-vaccenic acid and 10(E),12(Z)-conjugated linoleic acid) that make up 58% of the bio-binders and in two similar hydrocarbons (trans-2-undecene-1-ol and 2-linoleoyl glycerol) that have a similar number and placement of their double bonds. Fukui values show carbon atoms at each side of a simple double bond to be the most reactive positions of the aforementioned molecules.

Although the attacks can take place on the double bonds in a long carbon chain, the attacks are also possible in other forms of suitable hydrocarbons. Fukui values in the molecule can provide an indication of the process. For a double-attack stabilization mechanism to be successful, the molecule should allow both chains to attach to it with stable bonds. However, some conditions might prevent this from happening. For instance, closeness of an electrophilic element in the vicinity of the carbon may increase its Fukui values and make it vulnerable to an attack. However, it may simultaneously attract the released radical electron and neutralize the second attack. These conditions should be assessed together, with no single property being the sole benchmark for evaluating the possibility of the double-attack stabilization mechanism.

Mapping radical attacks. Stabilization happens as the radical electrons react to form a S—C bond. This process happens in two steps, with each step characterized by a radical attack. Calculations show that the feasible distance between the sulfur radical and the allylic carbon is higher for the first attack than that of the second. This comparison shows that the second attack is almost inevitable, given the same conditions for the first attack are met. The difference in the feasible attack distance between the first attack and the second attack even reaches two times the second-attack distance for some species. Among the modeled species, 10(E),12(Z)-conjugated linoleic acid proved to be the most desirable for radical attacks; however, the difference between the first and second attack radii is about 1.5 Å for the four chosen species.

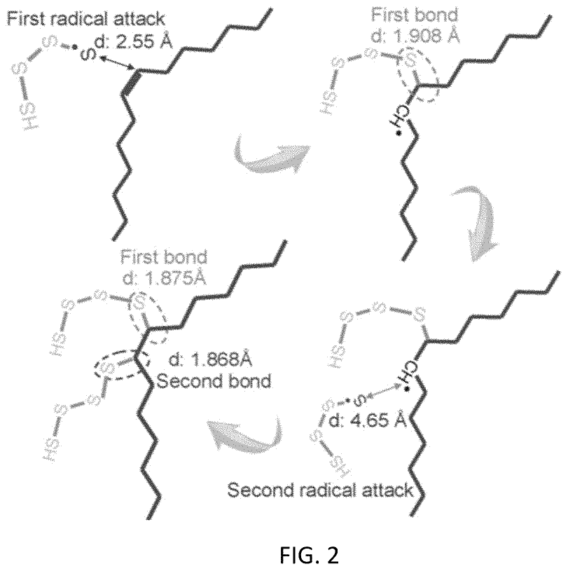

The lengths of these S—C bonds depend on the molecular structure of the reacting species. The length is near 1.90 Å for the first S—C bond formed. It is after the second attack and the establishment of the second S—C bond that the molecule stabilizes. This stabilization is indicated by the two characteristics of the second radical attack: the bond lengths for the second S—C bonds formed are shorter than that of the preliminary bonds, and after formation of the second S—C bond, the lengths of the previously established S—C bonds are reduced from an average of 1.95 Å to 1.85 Å. The absorption energy and the bond energy better describe the tendency for the formation of a sulfur-WCO polymer. Before the first bond forms, the absorption energy determines the intensity by which the two species interact and to a certain degree, the type of the bond they are likely to form. The proposed mechanism for the reaction of sulfur radicals with 7-tetradecene is shown in detail in FIG. 2, where the change to the S—C pair is chosen as the main marker for each step. The first radical chain is absorbed onto the reactive carbon atom at a distance of 2.55 Å. The initial S—C bond forms at 1.908 Å. The formation of this bond breaks the double bond, leaving behind a free electron on the second carbon of the newly broken bond. The presence of this electron enhances the reactivity of its respective carbon, thus allowing for a longer attraction distance, in this case 4.65 Å. The second S—C bond shows a shorter bond length, 1.886 Å. This coincides with the shortening of the first S—C bond (to 1.875 Å, ˜2%), indicating the stabilizing effect of the second attack and generally the entire process.

This mechanism is also hypothesized to be effective in some of the more well-known hydrocarbons, and it may be the mechanism behind the strong polymerization tendencies between dicyclopentadiene and sulfur. The results show relatively shorter feasible attack distances, while the difference between the first attack and second attack distances remains near 1.5 Å. The bond length values and feasible radical attack distances show the WCO mixture to be a viable rival to other species suitable for in situ sulfur polymerization.

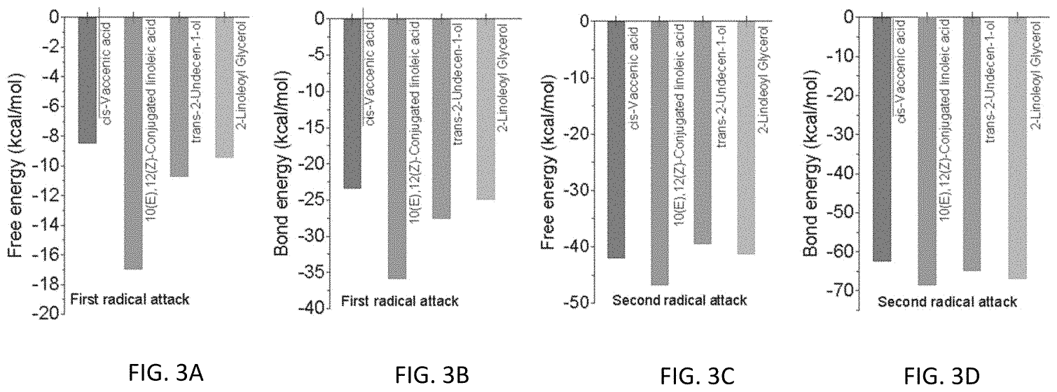

Although the maximum feasible bonding distance indicates the occurrence of this mechanism, the stability of such bonds can also be shown through the energy indexes. The absorption energy, which is the difference between the free energy values of the polymer species and the independent reactants, is an effective tool for evaluating the possibility of the formation of a sulfur-WCO polymer. Before the first bond forms, the absorption energy determines the intensity by which the two species may interact and to a certain degree, the type of the bond they are likely to form. FIGS. 3A-3D show the absorption tendency (represented by the free energy values) and the bonding energy values for the prominent species in WCO for both stages of polymerization. In the case of the initial radical attack, all selected molecules show appropriate tendency, with the 10(E),12(Z)-conjugated linoleic acid being the most desirable for a radical attack as shown in FIG. 3A, due to its large absorption radius. The bonds formed as a result of the first radical attack show negative values, with the same order as the absorption energy as shown in FIG. 3B. These values demonstrate the stability of the S—C bond formed. The free energy values for the second radical attack become much larger, nearly three or four times the energy values for the first attack as shown in FIG. 3C. The significant rise in the absorption energy, a representative of the bonding tendency, reinforces the hypothesis that the first attack acts as a trigger for the second attack. The bond energy follows the same trend, rising to three or four times the bond energy values for the initial S—C pair as shown in FIG. 3D. Observing the absorption energy for the secondary S—C bonds reveals that they are most likely to form, and the resulting bonds are more stable than the bonds formed after the first radical attack.

A majority of sulfur chains, if permitted enough time and motility, may stabilize certain carbonaceous species. These species are typically those with double bonds, with an oxygen atom in the vicinity (but not the immediate vicinity) of the potential radical-attack targets. Also, the chain that connects said carbon to the main structure may have alternating double bonds, to provide an even stronger vulcanization. The subsequent radical attack, provided these conditions are met, can strengthen previously formed S—C bonds. Increasing the temperature of the reaction increases the tendency of the sulfur radicals and hydrocarbons to interact. This is expected because of the reduced viscosity (which enhances mixing) and increased radicalization of the existing sulfur at higher temperatures. This is a recurring theme in the examined materials. There are, however, hydrocarbons for which this effect is minimal. Given a similar increase in temperature, the absorption tendency of 4-allyl-2,6-dimethoxyphenol rises from near 0 to a value of −3 kcal/mol. The rise in the absorption energy of the other molecules, although as high as 100%, changes little in terms of reactivity, as these molecules are already highly reactive in the presence of radical sulfur chains. The bond energy for the newly formed S—C bond is about 30 kcal/mol, which is higher than most of the S—C bonds analyzed in FIGS. 3A-3D. As for the second radical attack the hydrocarbons show similar susceptibility as compared with the hydrocarbons in WCO in FIGS. 3A-3D. This is also the same for the S—C bonds after the second attack, where both bonding energies are about 65 kcal/mol except for 2-methoxy-4-vinylphenol, for which the bond energy for the second bond is 40% lower than that of the first bond. In other cases, this difference is about 10-15%.

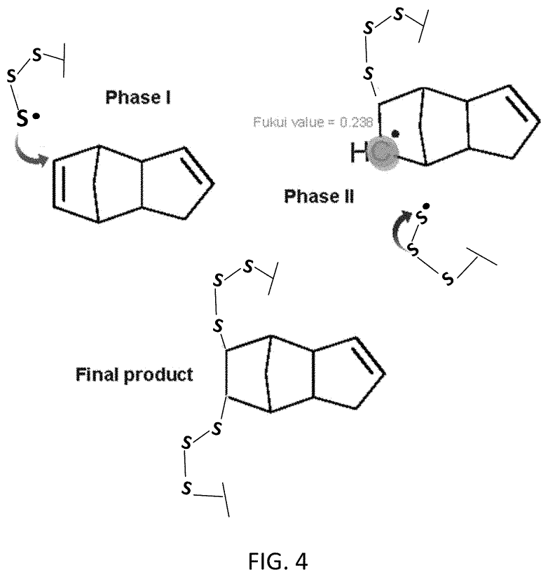

S—C amorphous compound. Successful attempts at creating sulfur-hydrocarbon copolymers in the past have shown that dicyclopentadiene (DCPD) is a strong polymerization agent for the radical sulfur chains at high temperatures. The first component, sulfur, a yellow solid at 25° C., becomes a fluid at nearly 120° C. as its octagonals break into radical chains. The second component, DCPD, is a ringed hydrocarbon with two double bonds. The result of their mixture at 160° C. is a polymer that forms in between previously isolated sulfur grains. These connected chains form an interconnected material. The overall reaction is shown in FIG. 4, where in each phase, the most reactive spots of the stabilizer (DCPD) are attacked by radical sulfur chains to finally create a stable copolymer. The glass transition temperature (T_{g}) better describes this progress. As the ratio of DCPD to sulfur increases from 7.5% to 22.5%, the copolymerization transforms higher shares of sulfur into the amorphous polymer. T_{g} values show this transition with the disappearance of the crystal phase from the mixture; higher shares of DCPD help create an amorphous setting with little to no sudden change in its behavior against rising temperature. X-ray diffraction (XRD) results confirm that DCPD has initiated copolymerization with sulfur, resulting in an amorphous polymeric form. The mechanical tests show that in the case of DCPD, the optimal ratio is 95% sulfur-5% DCPD, passing which the coherence of the specimen starts to break down.

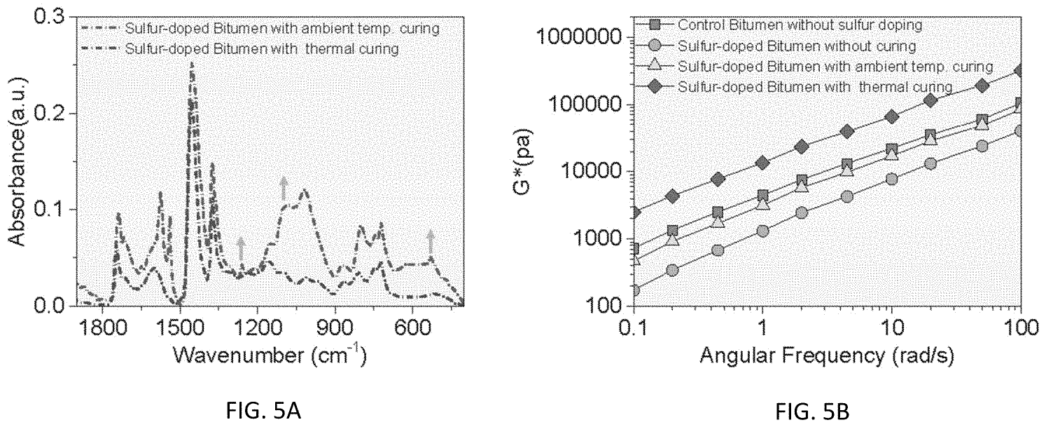

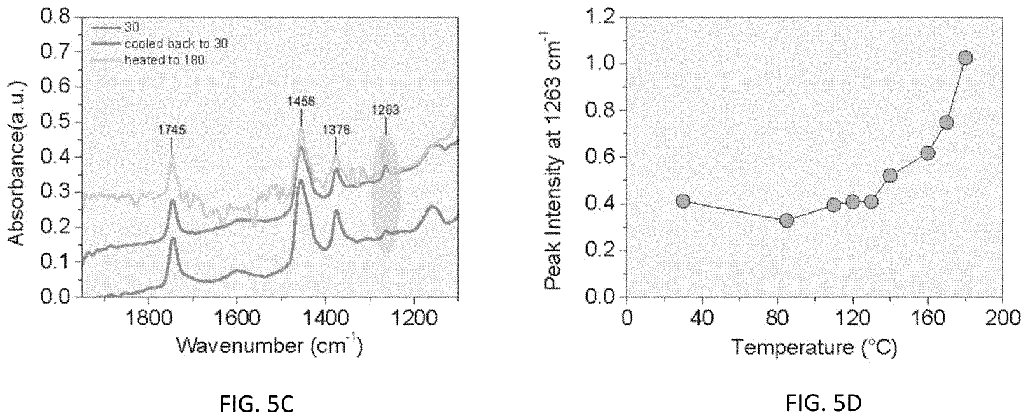

Evaluating the effects of the sulfur-WCO polymerization. As a crosslinker, the effective addition of sulfur greatly affects the structure of the bitumen. The sulfur radical attacks break alkene groups and form bonds between various detached hydrocarbons to create networks inside the mixture, which would change its overall mechanical performance. To achieve this, a particular curing procedure was designed. The effectiveness of this method was tested; the results are shown in FIG. 5A, where the structural changes to the S—WCO bio-binder are evident. FTIR observations show the thermal curing to be effective in promoting the formation of S—C bonds and the creation of a network inside the bitumen matrix. This was evidenced by a reduction in alkenes during the thermal curing shown in FIG. 5A. The peaks marking the C—C double bond (1620-1680 cm-1) are relaxed in the specimen with thermal curing, as well as the vinyl-related compounds (990-900 cm-1). This coincides with a reduction in the oxygen content (1260-1050 cm-1) in the mixture, which can be attributed to the successful release and burning of oxygen in the process. These observations demonstrate the effectiveness of the thermal curing method in creating an amorphous matrix where various species are linked via sulfur chains in an inhomogenous network. This is in agreement with the flattening of the sulfide interval (600-500 cm-1), possibly due to prevention of re-crystallization which promotes consolidation of sulfur chains in a C—S network.

FIG. 5B shows the results of the rheological analysis. Initially, it was observed that the addition of sulfur to the control bitumen significantly reduced the complex shear modulus of the control bitumen. The sample slowly started to regain its lost modulus as curing time progressed; however, it did not fully regain the lost modulus even after 60 days of curing. Mixing and reheating the sample at 150° C. for 30 min was not effective to fully regain the lost modulus. To facilitate the formation of sulfur free radicals, a specimen was melt-blended at 180° C. for 30 min. The chain reactions of sulfur free radicals and bitumen containing waste cooking oil not only helped the bitumen regain its lost modulus; they also led to an increase in the complex modulus. The complex modulus increased to become three times higher than that of the control bitumen as shown in FIG. 5B. This substantial increase was attributed to the chain reactions of sulfur radicals and unsaturated hydrocarbons in waste cooking oil. Without the stabilization, sulfur recrystallizes over time. However, in this case the stabilization helps give rise to the formation of permanent sulfur-carbon bonds. Evidence for the sulfur-carbon bond formation is shown in FIGS. 5C-5D as the peak intensity of S═C band at 1263 cm⁻¹ increases as the temperature increases from 30 to 180° C.

Underlying properties at the atomic scale. The formation of covalent sulfur-carbon bonds creates cohesive S—C species; depending on the level of sulfur integration, these cohesive S—C species are connected by Van der Waals (vdW) bonds. While the sulfur chains are covalently connected to the carbonaceous species to form the polymer, the amalgamate of the produced polymer is held together with relatively weak vdW interactions. These distinct connections (covalent S—C bonds and vdW interactions) create a chasm between the possible modes of failure at two different levels.

Failure in the covalent S—C bond was modeled as a function of strain placed on the polymer. With increasing displacement, the inherent twist in the polymer is straightened and the failure happens in the form of a break in one of the S—S bonds, as they usually have lower bonding energy compared with their counterparts in the polymer. The failure Van der Waals bonds happens less drastically than the breakage of a as the attraction gradually fades with increasing distance.

For the first mode of failure, three different species (ethyl vinyl ketone, 2-methoxy-4-vinylphenol, and 7-tetradecene) were compared by their stress-strain figures. In the first mode, where the failure happens at the break of a covalent bond, all three species show similar behavior: failure happens at 2.5 GPa and about 0.6 strain. For the second mode, although all three mentioned species have the same failure process, the maximum tolerated tensile stress and strain values vary. The 7-tetradecene shows the highest tolerated tensile stress: 0.21 GPa, corresponding with 0.12 strain. Ethyl vinyl ketone and 2-methoxy-4-vinylphenol show a lower peak for the tensile strength at 0.17 GPa and ˜0.7 strain. In addition, the high area under the stress-strain diagram of the 7-tetradecene demonstrates its tolerance for external stress and the subsequent deformations. The combined mechanisms of failure on two levels provide a high degree of stress and deformation tolerance, at the first stage mainly for preserving the main components, and at the second stage for delaying the overall rupture.

The cohesion in the bitumen matrix can be evaluated using a pull-out test, where the upper layer of the copolymer is slowly forced to slide over the lower layer (bitumen). The resistance recorded as the pull-out stress is used to determine the bonding energy between the two sliding matrices and therefore the existing cohesion between them. In full interaction mode, where both layers have maximum overlap, resistance to sliding is at its peak. With increasing displacement, the interaction between the layers is reduced; progressively more atoms from both sides pass the effective distance for interaction. The applied stress versus the displacement shows much higher shear resistance between sulfur polymer and bitumen versus the bitumen-bitumen interface. The difference increases as a share of the bitumen-bitumen shear strength with displacement, highlighting the possible effectiveness of sulfur polymer in binding the bitumen matrix together. The high cohesion means that the sulfur polymer-bitumen interface shows higher pull-out strength in a 25-30 Å interval than is shown by the bitumen-bitumen interface in 20-25 Å, once again stressing the beneficial role of WCO—S as a reinforcing additive for bitumen. To test the strength of the sole WCO—S polymer, the MD model was put under tensile stress in two phases: in the interatomic chemical bonding phase and in the intermolecular van der Walls phase. Stress-strain results at the interatomic scale attest to the superiority of the S—C bond that connects the radical sulfur chains to the 10(E),12(Z)-conjugated linoleic acid molecule, which shows higher ultimate stress corresponding with higher strain toleration. This is in complete agreement with the results shown in FIGS. 3A-3D, where the 10(E),12(Z)-conjugated linoleic acid showed itself to be the most attractive candidate due to its high absorption and the significant bond stability it provides when attached to a sulfur chain. At the intermolecular level, the addition of sulfur polymer enhances the overall mechanical performance of the matrix by increasing the ultimate tolerated stress by more than 30%. This is a result of the stiff sulfur polymer that has nearly double the elastic modulus of the bitumen. The results show that sulfur-waste cooking oil with long chains can form extensive entanglement between the species that form bitumen. This transformation unifies the previously vdW-attached species with these long chains and spreads the applied stress more evenly throughout the bituminous matrix.

### Catalyzed Inverse Vulcanization

Computation Details. Quantum-based molecular modeling, using the density functional theory (DFT) approach, was used to calculate the target interactions. DMol module and its numerical basis sets, from BIOVIA Materials Studio, were taken for DFT calculations. Perdew-Burke-Ernzerhof (PBE) type of generalized gradient approximation (GGA) was used as the exchange-correlation functional, and Grimme's correction was considered to include the long-range dispersion corrections (PBE-D). In an all-electron optimization, without imposing any geometric or symmetrical constraints, double-numerical basis with a polarization function, DNP, was used as the basis set. At this level of calculation (PBE-D/DNP) and choosing fine numerical integration grid for the quality of calculations, the tolerance on energy, maximum force, and displacement convergence are 1.0×10-5 hartree, 2.0×10-3 hartree Å-1, and 5.0×10-3 Å, respectively.

The interaction (binding) energy between two target constituents, A and B, is calculated as the energy difference (ΔE) between the complex formed, AB, and its components A and B, when they are in their lowest energy states described by Eq. 1.

ΔF=E_{AB}−(E_{A}+E_{B}) (1)

In Eq. 1, E_{AB} is the energy of the newly formed complex (AB), and EA and EB respectively refer to the optimized energies of the initial constituents A and B.

Elemental sulfur, which is commercially available and used in this study, is a solid crystalline substance that is stable in two allotropes: orthorhombic (S_{α}), and monoclinic (S_{β}). S_{α} and S_{β} allotropes of sulfur are the most stable forms of sulfur in normal conditions found in symmetrical cyclic structures, D_{4d} (crown-shaped), with S—S bond energy of −53.9 kcal/mol. The most stable form of sulfur at room temperature, solid S_{α}, is converted to S_{β} at temperatures between 95° C. and 119° C. (sulfur's melting point), and in a reversible reaction Sp crystals back to S_{α} when the system cools down. With raising the temperature, starting at 119° C. (sulfur's melting point), S_{β} crystals turn into the amber-colored liquid sulfur (S_{λ}) which structurally still contains cyclic S₈ molecules, and other cyclic molecules with 6-20 sulfur atoms. Although there is no agreement on the starting temperature of homolytic fission for S₈, mostly about 159° C. (floor temperature) is known as the temperature at which all the S₈ rings open up to long spiral-chain molecules. There are also reports indicating that homolytic scission of S—S bonds occurs even at temperatures lower than the melting point (110-118° C.).

This process, called “ring-opening polymerization”, leads to a substantial concentration of sulfur chains that entangle, increasing the viscosity of sulfur. Increasing the temperature above 159° C. makes the polymeric sulfurs unstable and promotes depolymerization back to the formation of cyclic S₈. Ring-closing depolymerization leads to shortening the sulfur chains and decreasing viscosity. “Ring-opening polymerization” and “ring-closing depolymerization” are two accepted mechanisms for the performance of sulfur atoms at high temperatures.

In the presence of organic fatty acid (oleic acid) as the crosslinker, the ring-opening process of sulfur is followed by the reaction of sulfur radicals with fatty acid molecules and formation of S—C bonds, directly impacting the elasticity of the matrix. This could be a reversible reaction when temperature decreases, leading to the formation of thiyl radicals (R\dot{S}) of polysulfides, increasing the crystalline state of sulfur by expelling S₈ or other cyclic sulfur species.

The target organic crosslinker, oleic acid, is classified as a monounsaturated omega-9 fatty acid. Olefin functionality (C═C) of fatty acids in general plays a role in reactivity of fatty acids. In omega-9, oleic acid, case, C═C double bond places on the ninth carbon from the terminal methyl end.

In the inverse vulcanization mechanism, the crosslinking reaction of sulfur with fatty acids is initiated by a ring-opening process of elemental sulfur (S₈) leading to the formation of thiyl radicals (R\dot{S}), polysulfide radicals (R\dot{S}n) and ally radicals (—CH₂—CH═CH—CH—CH₂—) related to the H abstraction of fatty acid backbone. These major intermediates ultimately undergo the radical reactions leading to the polysulfide crosslinks at olefinic (—C═C—) or allylic (—CH═CH—CH—) sites.

A part of crosslinking reactions is described through the general thiol-ene reaction (RSH+—C═C—) in which an initially-generated sulfur radical (R\dot{S}) undergoes an additional reaction with π bond of C═C to form the C—S bond. In polymer network formation, the radical mediated thiol-ene reactions (R\dot{S}+—C═C—) are unique in that they are readily accomplished under mild conditions with high yield and good functional group tolerance (atom-economic reaction). However, the initiation of thiol-ene reactions can be affected by a wide variety of substances acting as a catalyst.

### DFT-Based Modeling: Addition Reactions of Free Sulfur Radical to Oleic Acid.

DFT approach at the PBE-D/DNP level provides further insight into the interaction of elemental sulfur with the target fatty acid (oleic acid), with a focus on the broken ring of sulfur containing mono or diradicals of sulfur. In this analysis, the chain of elemental sulfur (S₈) is reduced to six sulfur atoms (S₆) to reduce the computational cost. Two models of the radical reaction of \dot{S}—(S)₄—\dot{S} chain with olefinic (—C═C—) and allylic (—CH═CH—ĊH—) sites of oleic acid are analyzed. The formation of allylic radicals (—CH═CH—ĊH—) on the backbone of fatty acid may be explained by the abstraction of allylic H through attacking the sulfur radicals originating from the sulfur ring-opening process.

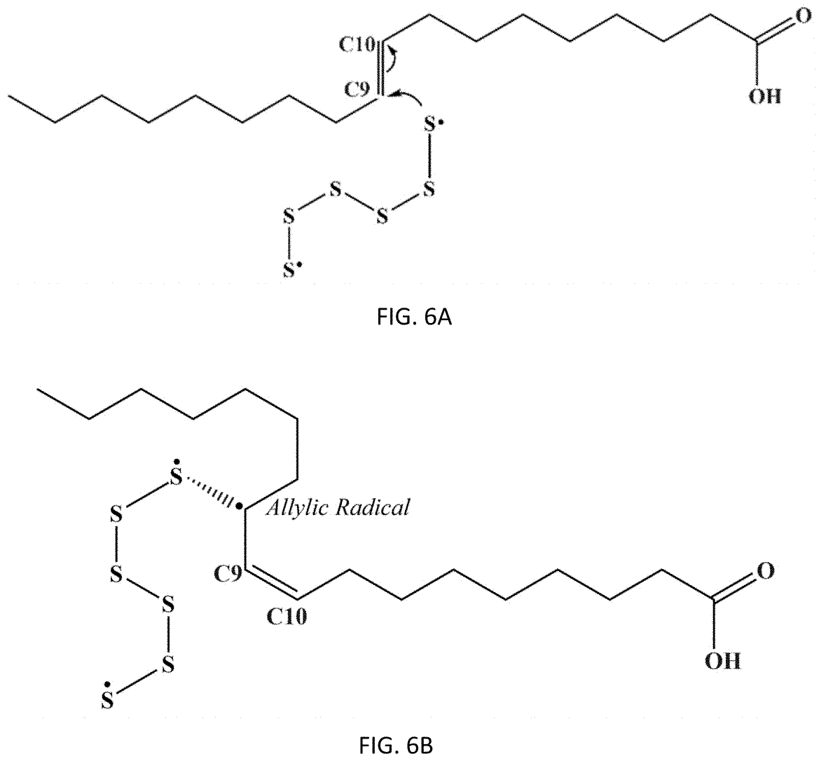

Under the optimum conditions, triplet state of \dot{S}—(S)₄—\dot{S} is more stable than singlet state by 3.4 kcal/mol. Free radical attack of \dot{S}—(S)₄—\dot{S}, in triplet state, to olefinic site depicted in FIG. 6A generates a carbon-centered radical. This reaction is associated with ˜−16 kcal/mol stabilization energy; −15.9 kcal/mol when the diradical product is in its triplet spin state and −16.2 kcal/mol when the diradical product is in singlet state. The low value of stabilization energy implies that the radical product, containing one carbon-centered radical and one-sulfur centered radical, is not very stable. However, if the process goes through this way, the resulting carbon-centered radical may add across another —C═C— functional group and generates another carbon-centered radical. Through this chain growth cycle, the molecular weight of the system increases gradually, and elasticity is ultimately achieved.

The second mechanism is the formation of allylic carbon on the backbone of oleic acid which is described by the H abstraction on oleic acid by sulfur radicals. The DFT results for H abstraction by \dot{S}—(S)₄—\dot{S} polysulfide show −21.07 kcal/mol and −24.50 kcal/mol energy release for this reaction, when diradicals of sulfur are in singlet and triplet states, respectively, Eq. 2.

\dot{S}—(S)₄—\dot{S}+CH₃—(CH₂)₇—CH═CH—(CH₂)₇—CO₂H→\dot{S}—(S)₄—SH+CH₃—(CH₂)₇—CH═CH—(ĊH)—(CH₂)₆—CO₂H (2)

ΔE=−21.07 kcal/mol \dot{S}—(S)₄—\dot{S} is in singlet state
ΔE=−24.50 kcal/mol \dot{S}—(S)₄—\dot{S} is in triplet state

The typical organic molecule used in this study is a monounsaturated fatty acid containing just one —C═C— double bond. However, in polyunsaturated fatty acids containing conjugated diolefin functional group (—C═C—C═C—), addition of a free radical to diene group can produce an allylic radical (—C—Ċ—C═C—) that results in several structural isomers, and ultimately several adducts.

Regardless of the chemical agent responsible for generating the allylic radical, this radical is very stable. Allylic as well as the benzylic radicals take advantage of resonance effect through which unpaired electron is delocalized over the conjugated pi bonds. With two resonance forms (—CH═CH—ĊH—↔—ĊH—CH═CH—), and delocalization of an unpaired electron over three carbon centers, the allylic radical is electronically symmetrical, which means that addition reaction of sulfur can occur on either side. Resonance structures of allylic radical provide considerable stability for this radical compared to its counterparts in alkyl radicals.

FIG. 6B depicts the chemical reaction between the sulfur radical and oleic acid through the allylic radical. Binding interaction in this reaction is associated with −72.3 kcal/mol and −68.8 kcal/mol for the situations that polysulfide diradical (\dot{S}—(S)₄—\dot{S}) is in singlet state and triplet state, respectively (Eq. 3). Considering the stability of the allylic radical and its energetically efficient interactions with the sulfur radicals, this pathway could be a potential mechanism for crosslinking the sulfur chains by the oleic acid.

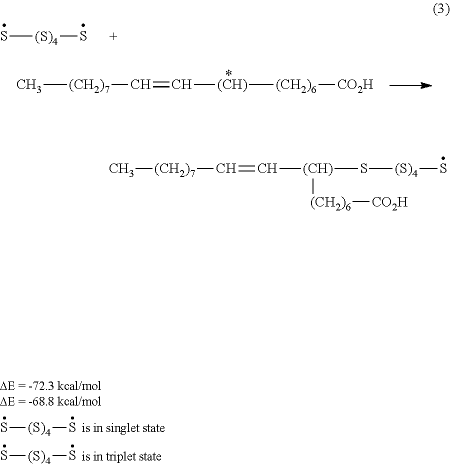

Molecular Modeling of Zinc, Magnesium and Calcium Fatty Acid Esters. Zinc fatty acid ester, made from the reaction between fatty acid and zinc oxide (ZnO), is an activator in conventional vulcanization. Other fatty acids (co-activators) including oleic, lauric, palmitic, and stearic acids can be used for this purpose. Zinc oxide can also be used in inverse vulcanization in preparing high-sulfur-content polymers.

Due to the poor miscibility between crosslinker (e.g., organic phase) and molten sulfur (e.g., inorganic phase), the activator, as the phase transfer agent, brings the crosslinker in proximity to sulfur, developing the formation of S-rich polymer. In a mechanism proposed for catalyzed inverse vulcanization using L-M-L (M=metal, L=ligand) as the activator, the catalyzed polymerization proceeds by insertion the sulfur atoms between the metal and ligand (L-M-S—Sₙ—S-L). The newly made complex, carrying the sulfur atoms, brings the sulfur atoms (e.g., sulfur phase) into the proximity of an organic crosslinker (e.g., oil phase) and lowers the energy barrier for the formation of C—S bonds.

In the present disclosure, oleic acid can play a dual role in catalyzed inverse vulcanization; an organic crosslinker and an activator precursor through formation of metal oleate as depicted in Eq. 4.

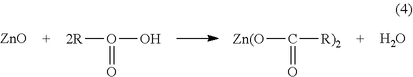

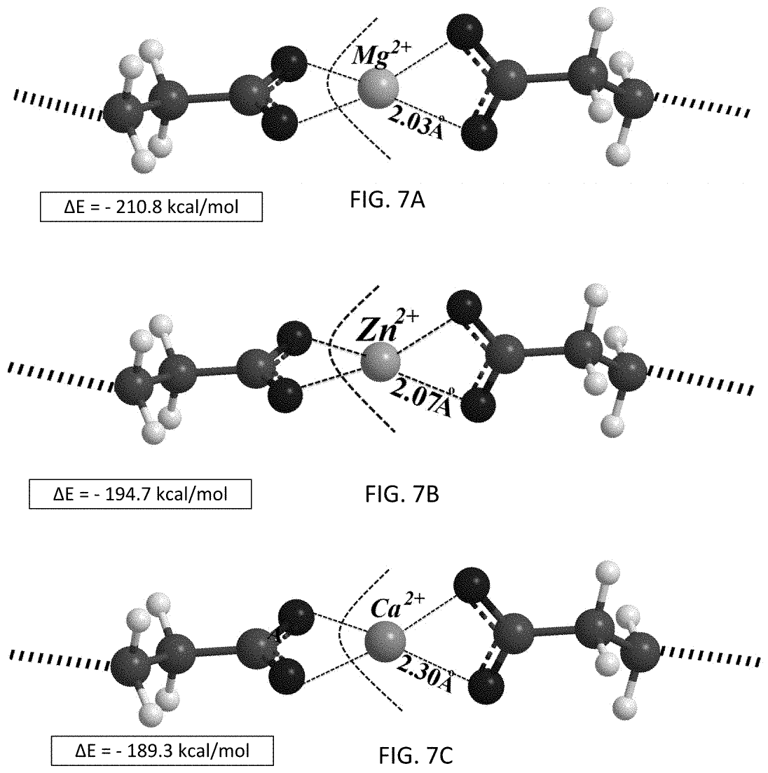

FIGS. 7A-7C show Zn, Mg and Ca metal salts of oleic acid with different strengths in their coordination bonds that eventually impact their coordination with sulfur atoms. The results indicate, at the PBE-D/DNP level, the following order for the stability of the L-M . . . L (M=Zn²⁺, Mg²⁺, Ca²⁺ and L=RCOO⁻ ligand) interactions: Mg>Zn>Ca with the binding energy values ΔE=−210.8 kcal/mol>−194.7 kcal/mol>−189.3 kcal/mol, respectively. This trend of energy indicates that coordination complexes of Mg oleate are better stabilized compared to Zn or Ca.

The function of metal ions (Zn²⁺, Mg²⁺, Ca²⁺) as the Lewis acid, and RCOO⁻ as the Lewis base, rationalizes the binding interactions and corresponding energies obtained here. The size and charge of the metal cations identify their acidity. Considering the same charge on three cations, acidity follows the ionic radius of cations: Mg²⁺ (0.65 Å)<Zn²⁺ (0.74 Å)<Ca²⁺ (0.94 Å) associated with the strongest acid (Mg²⁺) to weakest acid (Ca²⁺)

The performance of the metal ion as a transfer phase agent in an inverse vulcanization mechanism is determined when that metal is in the corresponding complex and beside the coordinated ligands as well as the organic crosslinker. As an example, free ZnO has not shown catalytic activity for inverse vulcanization reaction of sulfur with cross-linker ethylene glycol dimethacrylate, whereas zinc stearate did show some catalytic activity, and replacing the stearate ligand with diethyldithiocarbamate raised the catalytic activity notably.

A part of the mechanism mainly attributed to the catalyzed vulcanization and inverse vulcanization is formation of coordination complexes between the activator and sulfur atoms, though it is not clear whether this is a radical or ionic pathway. In a series of DFT calculations focusing on the priority of three different metals (Zn, Mg, and Ca), the binding interactions of ML (M=metal, L=oleate ligand (C₁₈H₃₃O₂⁻)) with two sulfur chains (H—S—S₄—S—) were analyzed when the terminal sulfur atoms are in different electronic state. The mechanism of (inverse) vulcanization is associated with homolytic or heterolytic fission of S₈ rings leading sulfur chains with radical or ionic character. Therefore, the terminal sulfur atoms of two sulfur chains are characterized with the following electronic states: 1—singlet spin state, when free radicals on two individual sulfur atoms are in up-down orientation, 2—triplet spin state, when free radicals on two individual sulfur atoms are in parallel orientation, 3—each ending sulfur atom carries a negative charge (both shared electrons retain on one atom), 4—one sulfur atom carries a negative charge and another one forms a free radical.

The results of interactions between each metal oleate, containing Zn, Mg and Ca, and two sulfur chains, in four electronic states discussed above, are provided in Table 3. Table 3 provides interaction energies (E, kcal/mol), and binding distances (d, Å) for coordination complexes of sulfur metal oleate (M=Mg, Zn, Ca) when terminal sulfur atoms are in different electronic states: a—sulfur atoms contain free radicals in up-down orientation (singlet state), b—sulfur atoms contain free radicals in parallel orientation (triplet state), c—each ending sulfur atom carries a negative charge, d—one sulfur atom carries a negative charge and the other one forms a free radical (doublet state).

As indicated in Table 3, ionic sulfur chains make higher interaction energies with metal oleate, due to the electrostatic interactions between the positively charged metal and negative sulfur atoms. Interaction of negatively charged sulfur chains with Mg, Zn, Ca oleates is respectively associated with energy release of −228.5, −225.6, and −222.9 kcal/mol. The energy values for interaction of sulfur radicals are less than −100 kcal/mol.

TABLE 3
Interaction energies (E, kcal/mol), and binding distances (d, A) for coordination
complexes of sulfur metal oleate (M = Mg, Zn, Ca).

| Interacting Constituents | 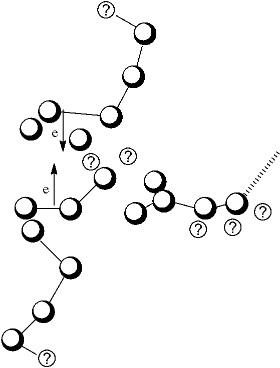 | 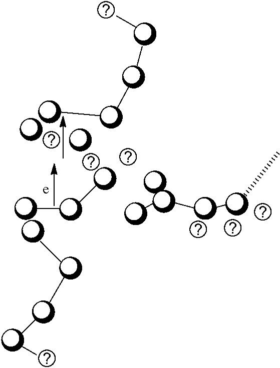 | 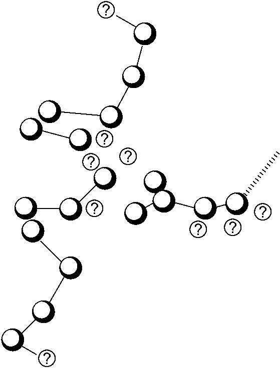 | 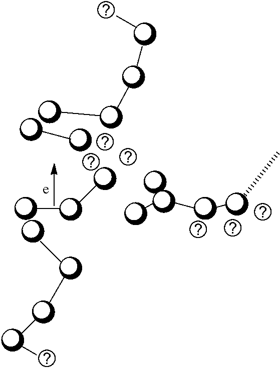 |
|---|---|---|---|---|
| (HS-S₄-S)₂ . . . | E = −71.7 | E = −87.6 | E = −228.5 | E = −163.7 |
| Mg(C₁₈H₃₃O₂)⁻ | d = 2.54 Å | d = 2.54 Å | d = 2.47 Å | d = 2.50 Å |
| (HS-S₄-S)₂ . . . | E = −70.7 | E = −86.1 | E = −225.6 | E = −152.0 |
| Zn(C₁₈H₃₃O₂)⁻ | d = 2.39 Å | d = 2.39 Å | d = 2.32 Å | d = 2.33 Å |
| (HS-S₄-S)₂ . . . | E = −59.1 | E = −76.5 | E = −222.9 | E = −145.2 |
| Ca(C₁₈H₃₃O₂)⁻ | d = 2.90 Å | d = 2.89 Å | d = 2.87 Å | d = 2.86 Å |

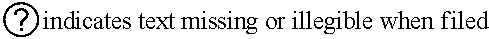

Regardless of the electronic nature of the terminal sulfur atoms, coordination complexes containing Mg metal show the highest values for interaction energies, indicating the higher stability for Mg complexes. The energy values for the corresponding Zn complexes are not much different from those of Mg complexes, further support the replacement of Zn with Mg in formation of metal oleate complexes. Of three examined metals here, Ca oleate shows the lowest energy values in interaction with sulfur chains.

Generally, Ca has the largest ionic radius (Mg²⁺ (0.65 Å)<Zn²⁺ (0.74 Å)<Ca²⁺ (0.94 Å)) with typical Ca—S distance 2.75 Å, followed by 2.37 Å for Mg—S and 2.26 Å for Zn—S. The similar trend is observed for their corresponding coordination complexes here (Table 3, d (Ca—S)>d (Mg—S)>d (Zn—S)). As indicated in Table 3, not only for ionic coordination complexes, c and d, but also for complexes containing sulfur radicals, a and b, calcium establishes the largest bond distance with sulfur ions or sulfur radicals, d=˜2.90 Å. A rule of thumb is that shorter metal-ligand distances, and hence tighter coordination ligand, is associated with the larger binding energy for that bond, although the rule is not expandable to all metal-ligand coordinations. In this analysis, Ca makes the loosest coordination sphere with sulfur chains, leading to the lowest binding energies (Table 3). Binding (interaction) energies for Mg and Zn complexes are comparable, giving support for the effectiveness of replacing of Zn with Mg in oleate compounds as an activator, although the binding distances of Mg—S are larger than those in Zn—S.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A sulfur copolymerization process comprising:
combining elemental sulfur with modified bitumen to yield a mixture, wherein the modified bitumen comprises waste vegetable oil;
blending the mixture; and
curing the mixture to yield a copolymerized modified bitumen.

2. The process of claim 1, wherein blending the mixture comprises melt-blending.

3. The process of claim 2, further comprising melt-blending at a temperature between about 160° C. and about 200° C.

4. The process of claim 1, wherein the curing occurs at ambient temperature.

5. The process of claim 1, wherein the mixture comprises between about 5 wt % and about 15 wt % of the elemental sulfur.

6. The process of claim 1, wherein the waste vegetable oil comprises one or more unsaturated organic monomers.

7. The process of claim 6, wherein the one or more unsaturated organic monomers independently comprise one or more unsaturated alcohols or unsaturated fatty acids.

8. The process of claim 7, wherein the unsaturated alcohols comprise glycerols.

9. The process of claim 6, wherein the elemental sulfur reacts to yield polysulfide chains.

10. The process of claim 9, wherein the polysulfide chains form a covalent bond with one of the unsaturated organic monomers.

11. An inverse vulcanization process comprising:
combining an unsaturated fatty acid and an alkaline earth metal (hydr)oxide to yield a mixture;
combining elemental sulfur with the mixture; and
processing the mixture to yield a sulfur copolymer.

12. The process of claim 11, wherein a weight ratio of the unsaturated fatty acid and the alkaline earth metal (hydr)oxide is in a range of about 2:1 to about 1:2.

13. The process of claim 11, wherein the unsaturated fatty acid has a carbon chain length of about 6 carbons to about 22 carbons.

14. The process of claim 13, wherein the unsaturated fatty acid is oleic acid.

15. The process of claim 11, further comprising sourcing the unsaturated fatty acid from a bio-oil.

16. The process of claim 11, wherein the bio-oil is waste vegetable oil.

17. The process of claim 11, wherein the alkaline earth metal (hydr)oxide comprises magnesium oxide or calcium oxide.

18. The process of claim 11, wherein combining the unsaturated fatty acid and the alkaline earth metal (hydr)oxide occurs at a temperature between 125° C. and 150° C.

19. The process of claim 11, wherein combining the unsaturated fatty acid and the alkaline earth metal (hydr)oxide occurs in a low shear mixer.

20. The process of claim 11, wherein the unsaturated fatty acid and the alkaline earth metal (hydr)oxide react to form a metal salt activator.
